(19) United States
(12) Patent Application Publication
(10) Pub. No.: US 2024/0409824 A1
(43) Pub. Date: Dec. 12, 2024

(54) WASTE PLASTIC PYROLYSIS OIL REFINING EQUIPMENT AND METHOD OF REFINING WASTE PLASTIC PYROLYSIS OIL

(71) Applicants: SK INNOVATION CO., LTD., Seoul (KR); SK GEO CENTRIC CO., LTD., Seoul (KR)

(72) Inventors: Heejung JEON, Daejeon (KR); Okyoun KIM, Daejeon (KR); Kayoung KIM, Daejeon (KR); Youngmoo PARK, Daejeon (KR); Howon LEE, Daejeon (KR)

(21) Appl. No.: 18/697,484

(22) PCT Filed: Oct. 27, 2022
(86) PCT No.: PCT/KR2022/016543

§ 371 Date: Apr. 1, 2024

(30) Foreign Application Priority Data
Oct. 29, 2021 (KR) 10-2021-0146884

(51) Int. Cl. C10G 49/00; B01J 8/02; C10G 45/02; C10G 65/04

(52) U.S. Cl. CPC C10G 49/002; B01J 8/0278; B01J 8/0285; C10G 45/02; C10G 65/04; B01J 2208/00176; C10G 2300/1003

(57) ABSTRACT

Provided is waste plastic pyrolysis oil refining equipment including: a guard bed 100 where a waste plastic pyrolysis oil and a hydrogen gas are introduced and hydrotreated at a first temperature in the presence of a hydrotreating catalyst to produce a fluid from which chlorine has been removed; a main bed 200 where the fluid and the hydrogen gas are introduced from the guard bed 100 and hydrotreated at a second temperature higher than the first temperature in the presence of a hydrotreating catalyst to produce a refined oil from which impurities have been removed; and a recovery tank 300 where the refined oil from which impurities have been removed is recovered from the main bed 200, wherein a temperature before the refined oil is recovered to the recovery tank 300 is maintained at 290° C. or higher and lower than 350° C.

### TECHNICAL FIELD

The present invention relates to waste plastic pyrolysis oil refining equipment and a method of refining a waste plastic pyrolysis oil.

### BACKGROUND ART

Waste plastics, which are manufactured using petroleum as a raw material, have a low recyclability and are mostly disposed of as garbage. These forms of wastes are decomposed in their natural state, and since the decomposition takes a long time, they pollute the soil and cause serious environmental pollution. As a method of recycling waste plastics, the waste plastics may be pyrolyzed and converted into an oil fraction, which is referred to as a waste plastic pyrolysis oil.

However, since a pyrolysis oil obtained by pyrolyzing waste plastics has a high content of impurities such as chlorine, nitrogen, and metal as compared with an oil fraction manufactured from crude oil by a common method, it may not be directly used as a high value-added fuel such as gasoline and diesel oil and should go through a refining process.

As such, as a refining method for removing impurities such as chlorine, nitrogen, and metal contained in the waste plastic pyrolysis oil, a dechlorination/denitrification method by reacting waste plastic pyrolysis oil and hydrogen in the presence of a hydrotreating catalyst, a method of removing chlorine contained in the waste plastic pyrolysis oil by adsorption using a chlorine adsorbent, or the like are known.

Specifically, U.S. Patent Registration No. 3935295 discloses a technology for removing chloride pollutants from various hydrocarbon oil fractions. The technology is a conventional technology of hydrotreating an oil fraction in the presence of a hydrotreating catalyst in a first reactor, introducing a fluid including hydrogen chloride (HCL) and a refined oil fraction produced at this time to a second reactor, and then removing a chlorine component included in the fluid by adsorption using an adsorbent.

However, as described in the conventional technology, when the oil fraction and hydrogen are reacted in the presence of a hydrotreating catalyst, a nitrogen compound and a chlorine compound such as hydrogen chloride produced with the refined oil fraction react to produce an ammonium salt (NH₄Cl), and this ammonium salt causes various process problems. Specifically, the ammonium salt produced inside the reactor by the reaction of the oil fraction and hydrogen causes corrosion of the reactor to decrease durability, and causes many process problems such as differential pressure occurrence and consequently lowered process efficiency.

In addition, a process of removing impurities by a water treatment is performed, with a refining method by a hydrotreatment in the presence of a hydrotreating catalyst, as a conventional refining method for removing impurities contained in a waste plastic pyrolysis oil. However, moisture is usually present at 0.2 to 1 wt % in a common waste plastic pyrolysis oil, and a moisture content in the waste plastic pyrolysis oil becomes excessive due to the water treatment. This causes corrosion throughout the process to lower process efficiency, and affects a catalyst to lower catalyst durability, thereby causing a problem of inability to perform the stable operation of refining equipment.

Therefore, in a refining process of a waste plastic pyrolysis oil containing impurities including chlorine and nitrogen, waste plastic pyrolysis oil refining equipment and a method of refining a waste plastic pyrolysis oil, which prevent or minimize production of an ammonium salt (NH₄Cl) by the reaction of a chlorine component and a nitrogen component, and minimize moisture to prevent corrosion or catalyst durability deterioration, are demanded.

### Related Art Document

### Patent Document

U.S. Patent Registration No. 3935295 (registration date: Jan. 27, 1976)

### DISCLOSURE

### Technical Problem

An object of the present disclosure is to provide waste plastic pyrolysis oil refining equipment and a method of refining a waste plastic pyrolysis oil, which prevent or minimize production of an ammonium salt (NH₄Cl), suppress reactor corrosion and differential pressure occurrence, and have improved durability and process efficiency, in a refining process of a waste plastic pyrolysis oil containing impurities including chlorine and nitrogen.

Another object of the present disclosure is to provide waste plastic pyrolysis oil refining equipment and a method of refining a waste plastic pyrolysis oil, which minimize moisture to prevent reactor corrosion and catalyst durability deterioration, thereby improving process stability, in a refining process of a waste plastic pyrolysis oil containing impurities including chlorine and nitrogen.

Still another object of the present disclosure is to provide waste plastic pyrolysis oil refining equipment and a method of refining a waste plastic pyrolysis oil, having a very low content of impurities such as chlorine, nitrogen, and metal and a very low content of olefin, and having excellent quality.

### Technical Solution

In one general aspect, waste plastic pyrolysis oil refining equipment includes: a guard bed 100 where a waste plastic pyrolysis oil and a hydrogen gas are introduced and hydrotreated at a first temperature in the presence of a hydrotreating catalyst to produce a fluid from which chlorine has been removed; a main bed 200 where the fluid and the hydrogen gas are introduced from the guard bed 100 and hydrotreated at a second temperature higher than the first temperature in the presence of a hydrotreating catalyst to produce a refined oil from which impurities have been removed; and a recovery tank 300 where the refined oil from which impurities have been removed is recovered from the main bed 200, wherein a temperature before the refined oil is recovered to the recovery tank 300 is maintained at 290° C. or higher and lower than 350° C.

In an exemplary embodiment of the present disclosure, the waste plastic pyrolysis oil may include 30 wt % or more of a medium to large hydrocarbon oil fraction of C10 or higher having a boiling point of 180° C. or higher.

In an exemplary embodiment of the present disclosure, the first temperature may be higher than 100° C. and lower than 300° C., and the second temperature may be higher than 300° C. and lower than 450° C.

In an exemplary embodiment of the present disclosure, a moisture content in the refined oil from which impurities have been removed in the main bed 200 may be less than 100 ppm.

In an exemplary embodiment of the present disclosure, a heating means 250 may be further included between the main bed 200 and the recovery tank 300.

In an exemplary embodiment of the present disclosure, a reaction pressure of the guard bed 100 and the main bed 200 may be more than 60 bar and less than 120 bar.

In an exemplary embodiment of the present disclosure, a liquid hourly space velocity (LHSV) ratio between the guard bed 100 and the main bed 200 may be 1:0.1 to 1:0.8.

In another general aspect, a method of refining a waste plastic pyrolysis oil includes: (S1) hydrotreating a waste plastic pyrolysis oil with a hydrogen gas at a first temperature in the presence of a hydrotreating catalyst to produce a fluid from which chlorine has been removed; (S2) hydrotreating the fluid with a hydrogen gas at a second temperature higher than the first temperature in the presence of a hydrotreating catalyst to produce a refined oil from which impurities have been removed; and (S3) recovering the refined oil from which impurities have been removed, wherein a temperature before the refined oil is recovered is maintained at 290° C. or higher and lower than 350° C.

In an exemplary embodiment of the present disclosure, the waste plastic pyrolysis oil may include 30 wt % or more of a medium to large hydrocarbon oil fraction of C10 or higher having a boiling point of 180° C. or higher.

In an exemplary embodiment of the present disclosure, the first temperature may be higher than 100° C. and lower than 300° C., and the second temperature may be higher than 300° C. and lower than 450° C.

In an exemplary embodiment of the present disclosure, a moisture content in the refined oil from which impurities have been removed in (S2) may be less than 100 ppm.

In an exemplary embodiment of the present disclosure, a reaction pressure in the hydrotreating of (S1) and (S2) may be more than 60 bar and less than 120 bar.

In an exemplary embodiment of the present disclosure, a liquid hourly space velocity (LHSV) ratio in the hydrotreating between (S1) and (S2) may be 1:0.1 to 1:0.8.

### Advantageous Effects

The waste plastic pyrolysis oil refining equipment and the method of refining a waste plastic pyrolysis oil according to the present disclosure prevent or minimize production of an ammonium salt (NH₄Cl), in a refining process of a waste plastic pyrolysis oil containing impurities including chlorine and nitrogen, suppress reactor corrosion and differential pressure occurrence, and improve durability and process efficiency.

In addition, the waste plastic pyrolysis oil refining equipment and the method of refining a waste plastic pyrolysis oil according to the present disclosure minimize moisture to prevent reactor corrosion and decreased catalyst durability, thereby improving process stability, in a refining process.

In addition, the waste plastic pyrolysis oil refining equipment and the method of refining a waste plastic pyrolysis oil according to the present disclosure have a very low content of impurities such as chlorine, nitrogen, and metal and a very low content of olefin, and have excellent quality.

### DESCRIPTION OF DRAWINGS

The above and other objects, features and advantages of the present invention will become apparent from the following description of preferred embodiments given in conjunction with the accompanying drawings, in which:

FIG. 1 is a process diagram which schematically shows waste plastic pyrolysis oil refining equipment according to the present disclosure.

### DETAILED DESCRIPTION OF MAIN ELEMENTS

100: guard bed
200: main bed
300: recovery tank

### Best Mode

Hereinafter, the waste plastic pyrolysis oil refining equipment and the method of refining a waste plastic pyrolysis oil according to the present disclosure will be described in detail with reference to the accompanying drawings.

The drawings illustrated in the present specification are provided by way of example so that the idea of the present invention may be sufficiently conveyed to a person skilled in the art. Therefore, the present invention is not limited to the provided drawings, but may be embodied in many different forms, and the drawings may be exaggerated in order to clear the spirit of the present invention.

Technical terms and scientific terms used in the present specification have the general meaning understood by those skilled in the art to which the present invention pertains unless otherwise defined, and a description for the known function and configuration obscuring the gist of the present invention will be omitted in the following description and the accompanying drawings.

The singular form of the term used herein may be intended to also include a plural form, unless otherwise indicated.

The numerical range used in the present specification includes all values within the range including the lower limit and the upper limit, increments logically derived in a form and span in a defined range, all double limited values, and all possible combinations of the upper limit and the lower limit in the numerical range defined in different forms. Unless otherwise defined in the specification of the present invention, values which may be outside a numerical range due to experimental error or rounding of a value are also included in the defined numerical range.

The term “comprise” mentioned in the present specification is an open-ended description having a meaning equivalent to the term such as “is/are provided”, “contain”, “have”, or “is/are characterized”, and does not exclude elements, materials, or processes which are not further listed.

The unit of % used herein without particular mention refers to % by weight, unless otherwise defined.

In refining a waste plastic pyrolysis oil, when the oil fraction and hydrogen are reacted in the presence of a hydrotreating catalyst, a nitrogen compound and a chlorine compound such as hydrogen chloride produced with the refined oil fraction react to produce an ammonium salt (NH₄Cl), and this ammonium salt causes various process problems. Specifically, the ammonium salt produced inside the reactor by the reaction of the oil fraction and hydrogen causes corrosion of the reactor to decrease durability, and causes many process problems such as differential pressure occurrence and consequently lowered process efficiency.

In addition, as a conventional refining method for removing impurities contained in a waste plastic pyrolysis oil, a process of removing impurities by a hydrotreatment with a method of refining by a water treatment in the presence of a hydrotreating catalyst is performed, but a moisture content in the waste plastic pyrolysis oil is increased by the water treatment, which causes corrosion throughout the process to lower process efficiency and affects a catalyst to decrease catalyst durability, so that the stable operation of refining equipment may not be performed.

Thus, the present disclosure provides waste plastic pyrolysis oil refining equipment including: a guard bed 100 where a waste plastic pyrolysis oil and a hydrogen gas are introduced and hydrotreated at a first temperature in the presence of a hydrotreating catalyst to produce a fluid from which chlorine has been removed; a main bed 200 where the fluid and the hydrogen gas are introduced from the guard bed 100 and hydrotreated at a second temperature higher than the first temperature in the presence of a hydrotreating catalyst to produce a refined oil from which impurities have been removed; and a recovery tank 300 where the refined oil from which impurities have been removed is recovered from the main bed 200, wherein a temperature before the refined oil is recovered to the recovery tank 300 is maintained at 290° C. or higher and lower than 350° C.

The waste plastic pyrolysis oil may be a hydrocarbon oil fraction mixture produced by pyrolyzing waste plastics, and the waste plastics may include solid or liquid wastes related to synthetic polymer compounds such as waste synthetic resin, waste synthetic fiber, waste synthetic rubber, and waste vinyl.

The hydrocarbon oil fraction mixture may include impurities such as a chlorine compound, a nitrogen compound, and a metal compound, in addition to a hydrocarbon oil fraction, may include impurities present in the form of a compound to which chlorine, nitrogen, or metal is bonded in the hydrocarbon, and may include hydrocarbons in the form of olefin. Specifically, the waste plastic pyrolysis oil may contain 300 ppm or more of nitrogen and 30 ppm or more of chlorine, and may contain 20 vol % or more of olefin (1 atm, 25° C.), 1 vol % or more of conjugated diolefin (1 atm, 25° C.), and 0.1 to 1 wt % or more of moisture. However, the content of impurities is only a specific example which may be included in the waste plastic pyrolysis oil, and the composition of the waste plastic pyrolysis oil is not limited thereto.

In an exemplary embodiment of the present disclosure, the waste plastic pyrolysis oil may include 30 wt % or more of a medium to large hydrocarbon oil fraction of C10 or higher having a boiling point of 180° C. or higher. Specifically, the waste plastic pyrolysis oil may include 30 wt % or more of a hydrocarbon oil fraction of C10 or higher having a boiling point of 180° C. or higher including linear paraffin and alpha methyl paraffin and 30 wt % or less of a hydrocarbon oil fraction of C10 or lower including naphtha. When the waste plastic pyrolysis oil satisfying the hydrocarbon oil fraction composition described above is used as a raw material, a refining process may be performed only by a hydrotreatment without an additional process such as oligomerization or cracking, and there is almost no difference in a molecular weight distribution between a reactant and a product before/after a refining process, thereby having an effect of removing impurities.

In the guard bed 100, a waste plastic pyrolysis oil and a hydrogen gas may be introduced and hydrotreated at a first temperature in the presence of a hydrotreating catalyst to produce a fluid from which chlorine has been removed.

In the main bed 200, the fluid and the hydrogen gas may be introduced from the guard bed 100 and hydrotreated at a second temperature higher than the first temperature in the presence of a hydrotreating catalyst to produce a refined oil from which impurities have been removed.

The kind of each component removed from the guard bed 100 and the main bed 200 may be determined by a reaction temperature. The hydrotreating in the guard bed 100 may be performed at the first temperature to remove chlorine, and the hydrotreating in the main bed 200 may be performed at the second temperature higher than the first temperature to remove impurities including nitrogen.

The guard bed 100 and the main bed 200 in which the hydrotreating is performed are connected in plurality to perform the hydrotreating, in which chlorine is first removed in the guard bed 100 and then impurities including nitrogen are removed in the main bed 200, thereby minimizing the production and the accumulation of an ammonium salt (NH₄Cl) in the reactor.

In an exemplary embodiment of the present disclosure, the first temperature may be higher than 100° C. and lower than 300° C., and the second temperature may be higher than 300° C. and lower than 450° C.

When the hydrotreating is performed in the range of the first temperature, chlorine may be mainly removed, and the first temperature may be, specifically 120 to 250° C., more specifically 150 to 230° C.

When the hydrotreating is performed in the range of the second temperature, impurities including nitrogen may be removed, and also a moisture content in the produced refined oil is minimized, thereby preventing corrosion during the process and catalyst deactivation. When the temperature is 300° C. or lower, moisture in the waste plastic pyrolysis oil may not be effectively removed to cause corrosion during the process, and the moisture affects catalyst durability to lower catalytic activity. When the temperature is 450° C. or higher, a thermal cracking side reaction occurs to cause catalyst deactivation such as coking. When the second temperature is specifically 350 to 420° C., more specifically 370 to 400° C., a process corrosion problem is solved and the catalytic activity is maintained, and thus, the range is preferred.

A difference between the first temperature and the second temperature may be 50 to 350° C., specifically 50 to 280°, and more specifically 50 to 200° C., but is only an example and the difference between the first temperature and the second temperature is not limited thereto.

A moisture content in the refined oil from which impurities have been removed in the main bed 200 may be less than 100 ppm. As described above, the reaction temperature of the main bed 200 is set to higher than 300° C. and less than 450° C. to effectively remove the moisture in the waste plastic pyrolysis oil, thereby obtaining a refined oil having a moisture content of less than 100 ppm. The moisture content may be specifically less than 80 ppm, more specifically less than 60 ppm.

Specifically, a first reaction area provided with a hydrotreating catalyst is present in the guard bed 100. The waste plastic pyrolysis oil and the hydrogen gas are introduced to the reaction area, and are hydrotreated at the first temperature to remove chlorine from the waste plastic pyrolysis oil and also remove a part of olefin and metal impurities together. Specifically, a hydrogenation reaction of the waste plastic pyrolysis oil occurs in the presence of a hydrotreating catalyst and chlorine is mostly removed from the waste plastic pyrolysis oil to produce hydrogen chloride. Besides, a part of olefin is removed and other metal impurities are removed from the waste plastic pyrolysis oil. A fluid including a dechlorinated oil fraction, hydrogen chloride, and unreacted hydrogen is introduced to the main bed 200.

The guard bed 100 may have no separate gas outlet, and thus, the fluid including a dechlorinated oil fraction, hydrogen chloride, and unreacted hydrogen from the guard bed 100 may be introduced as it is to the main bed 200.

A second reaction area provided with a hydrotreating catalyst is present in the main bed 200. The fluid and the hydrogen gas are introduced from the guard bed 100 to the second reaction area, and may be hydrotreated at the second temperature to remove impurities from the fluid. Impurities including nitrogen, oxygen, sulfur, and the like may be all removed with hydrogen chloride and unreacted hydrogen gas in the fluid, and during the process, a mixed gas including hydrogen chloride, ammonia, water vapor, hydrogen sulfide, and the like may be produced. The main bed 200 may be provided with a gas outlet which discharges the mixed gas to the upper portion of the second reaction area, and an oil fraction outlet which discharges a refined oil from which impurities have been removed to the lower portion of the second reaction area. The mixed gas in the fluid hydrotreated at the second temperature is discharged through a gas outlet, thereby producing a refined oil from which impurities have been removed.

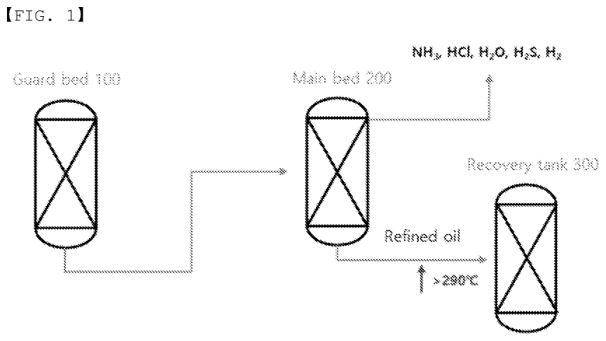

The refined oil from which impurities have been removed may be recovered to the recovery tank 300 from the main bed 200. The refined oil may be transferred from the oil fraction outlet of the main bed 200 and recovered in the recovery tank 300, and a temperature before the refined oil is recovered to the recovery tank 300 may be maintained at 290° C. or higher and lower than 350° C. As shown in FIG. 1, the temperature is maintained at 290° C. or higher before the refined oil is recovered to the recovery tank 300, thereby preventing the production of an ammonium salt (NH₄Cl) from remaining impurities present in the refined oil and obtaining high-quality refined oil having a minimized moisture content. When the temperature before the refined oil is recovered is 290° C. or lower, moisture may be condensed or differential pressure may occur by the production of an ammonium salt (NH₄Cl), and when the temperature is 350° C. or higher, the catalyst may be deactivated by the occurrence of a thermal cracking side reaction.

In an exemplary embodiment of the present disclosure, a heating means 250 may be further included between the main bed 200 and the recovery tank 300. By providing the heating means between the main bed 200 and the recovery tank 300, the temperature before the recovery to the recovery tank 300 may be maintained at 290° C. or higher. The heating means may be, for example, an electric heater, a steam heater, an air dryer, and the like, which is presented only an example, and the heating means is not interpreted as being limited thereto.

In an exemplary embodiment of the present disclosure, a reaction pressure of the guard bed 100 and the main bed 200 may be more than 60 bar and less than 120 bar. Under the conditions of a low pressure of 60 bar or less, impurities including chlorine and nitrogen may not be effectively removed, and under the conditions of a high pressure of 120 bar or more, production of an ammonium salt (NH₄Cl) may be promoted. The reaction pressure may be, specifically 65 bar to 110 bar, and more specifically 70 bar to 100 bar.

In an exemplary embodiment of the present disclosure, a liquid hourly space velocity (LHSV) ratio between the guard bed 100 and the main bed 200 may be 1:0.1 to 1:0.8. When it is satisfied, impurities may be effectively removed through the guard bed 100 and the main bed 200, the activity of the hydrotreating catalyst may be maintained with high activity for a long time, and process efficiency may be improved.

A volume flow ratio based on 1 atm between the waste plastic pyrolysis oil introduced to the guard bed 100 and the fluid and hydrogen introduced to the main bed 200 may be 1:300 to 3,000. The volume ratio may be any ratio at which a hydrotreatment may be performed, and specifically 1:300 to 3,000, more specifically 1:500 to 2,500, based on 1 atm. However, it is described as an example, and is not limited thereto.

The hydrotreating catalyst may be any various known kinds of catalysts as long as it is a catalyst to perform a hydrogenation reaction in which hydrogen is added to a hydrocarbon oil fraction of a waste plastic pyrolysis oil. As a specific example, the hydrotreating catalyst may include any one or two or more selected from a hydrodesulfurization catalyst, a hydrodenitrification catalyst, a hydrodechlorination catalyst, a hydrodemetallization catalyst, and the like. The catalyst allows the denitrification reaction or the dechlorination reaction to be also performed depending on the conditions such as temperature described above, as a demetallization reaction is performed. As a specific example, the catalyst may be those including an active metal having hydrotreating catalytic ability, and preferably, may be an active metal supported on a support. Any active metal may be used as long as it has required catalytic ability, and for example, may include any one or more selected from molybdenum, nickel, and the like. Any support may be used as long as it has durability to support the active metal, and for example, may include any one or two or more selected from metal including any one or two or more selected from silicon, aluminum, zirconium, sodium, and titanium manganese, and the like; oxides of the metal; and carbon-based materials including any one or two or more selected from carbon black, active carbon, graphene, carbon nanotubes, graphite, and the like; and the like. As a specific example, the hydrotreating catalyst may be a catalyst which is a support on which an active metal including 0.1 to 10 wt % of nickel and 0.1 to 30 wt % of molybdenum with respect to the total weight is supported. However, it is described only as a specific example, and the present disclosure is not interpreted as being limited thereto.

In addition, the present disclosure provides a method of refining a waste plastic pyrolysis oil including: (S1) hydrotreating a waste plastic pyrolysis oil with a hydrogen gas at a first temperature in the presence of a hydrotreating catalyst to produce a fluid from which chlorine has been removed; (S2) hydrotreating the fluid with a hydrogen gas at a second temperature higher than the first temperature in the presence of a hydrotreating catalyst to produce a refined oil from m which impurities have been removed; and (S3) recovering the refined oil from which impurities have been removed, wherein a temperature before the refined oil is recovered is maintained at 290° C. or higher and lower than 350° C.

The waste plastic pyrolysis oil may be a hydrocarbon oil fraction produced by pyrolyzing waste plastics, and the waste plastics may include solid or liquid wastes related to synthetic polymer compounds such as waste synthetic resin, waste synthetic fiber, waste synthetic rubber, and waste vinyl.

The hydrocarbon oil fraction mixture may include impurities such as a chlorine compound, a nitrogen compound, and a metal compound, in addition to a hydrocarbon oil fraction, may include impurities present in the form of a compound to which chlorine, nitrogen, or metal is bonded in the hydrocarbon, and may include hydrocarbons in the form of olefin. Specifically, the waste plastic pyrolysis oil may contain 300 ppm or more of nitrogen and 30 ppm or more of chlorine, and may contain 20 vol % or more of olefin (1 atm, 25° C.), 1 vol % or more of conjugated diolefin (1 atm, 25° C.), and 0.1 to 1 wt % or more of moisture. However, the content of impurities is only a specific example which may be included in the waste plastic pyrolysis oil, and the composition of the waste plastic pyrolysis oil is not limited thereto.

In an exemplary embodiment of the present disclosure, the waste plastic pyrolysis oil may include 30 wt % or more of a medium to large hydrocarbon oil fraction of C10 or higher having a boiling point of 180° C. or higher. Specifically, the waste plastic pyrolysis oil may include 30 wt % or more of a hydrocarbon oil fraction of C10 or higher having a boiling point of 180° C. or higher including linear paraffin and alpha methyl paraffin and 30 wt % or less of a hydrocarbon oil fraction of C10 or lower including naphtha. When the waste plastic pyrolysis oil satisfying the hydrocarbon oil fraction composition described above is used as a raw material, a refining process may be performed only by a hydrotreatment without an additional process such as oligomerization or cracking, and there is almost no difference in a molecular weight distribution between a reactant and a product before/after a refining process, thereby having an effect of removing impurities.

In (S1), a waste plastic pyrolysis oil may be hydrotreated with a hydrogen gas at a first temperature in the presence of a hydrotreating catalyst to produce a fluid from which chlorine has been removed; and in (S2), the fluid may be hydrotreated with a hydrogen gas at a second temperature higher than the first temperature in the presence of a hydrotreating catalyst to produce a refined oil from which impurities have been removed.

The kind of each component removed in the hydrotreating in (S1) and (S2) may be determined by a reaction temperature. The hydrotreating (S1) may be performed at a first temperature to remove chlorine, and the hydrotreating (S2) may be performed at a second temperature higher than the first temperature to remove impurities including nitrogen.

The hydrotreating in (S1) and (S2) is continuously performed, and chlorine is first removed in (S1) and impurities including nitrogen is removed in (S2), thereby minimizing the production and the accumulation of an ammonium salt (NH₄Cl) in the reactor.

In an exemplary embodiment of the present disclosure, the first temperature may be higher than 100° C. and lower than 300° C., and the second temperature may be higher than 300° C. and lower than 450° C.

When the hydrotreating is performed in the range of the first temperature, chlorine may be mainly removed, and the first temperature may be 120 to 250° C., and more specifically 150 to 230° C.

When the hydrotreating is performed in the range of the second temperature, impurities including nitrogen may be removed, and also a moisture content in the produced refined oil is minimized, thereby preventing corrosion during the process and catalyst deactivation. When the temperature is 300° C. or lower, moisture in the waste plastic pyrolysis oil may not be effectively removed to cause corrosion during the process, and the moisture affects catalyst durability to lower catalytic activity. When the temperature is 450° C. or higher, a thermal cracking side reaction occurs to cause catalyst deactivation such as coking. When the second temperature is specifically 350 to 420° C., more specifically 370 to 400° C., a process corrosion problem is solved and the catalytic activity is maintained, and thus, the range is preferred.

A difference between the first temperature and the second temperature may be 50 to 350° C., specifically 50 to 280°, and more specifically 50 to 200° C., but is only an example and the difference between the first temperature and the second temperature is not limited thereto.

A moisture content in the refined oil from which impurities have been removed in (S2) may be less than 100 ppm. As described above, the reaction temperature of (S2) is set to higher than 300° C. and less than 450° C. to effectively remove the moisture in the waste plastic pyrolysis oil, thereby obtaining a refined oil having a moisture content of less than 100 ppm. The moisture content may be specifically less than 80 ppm, more specifically less than 60 ppm.

Specifically, the hydrotreating (S1) is performed at the first temperature to remove chlorine from the waste plastic pyrolysis oil and also remove a part of olefin and metal impurities together. Specifically, a hydrogenation reaction of the waste plastic pyrolysis oil occurs in the presence of a hydrotreating catalyst and chlorine is mostly removed from the waste plastic pyrolysis oil to produce hydrogen chloride. Besides, a part of olefin is removed and other metal impurities are removed from the waste plastic pyrolysis oil. Thus, the fluid including a dechlorinated oil fraction from which other impurities have been removed, hydrogen chloride, and unreacted hydrogen is produced.

The hydrotreating (S2) is performed at the second temperature to produce a refined oil from which impurities have been removed, from the fluid. Impurities including nitrogen, oxygen, sulfur, and the like may be all removed with hydrogen chloride and unreacted hydrogen gas in the fluid, and during the process, a mixed gas including hydrogen chloride, ammonia, water vapor, hydrogen sulfide, and the like may be produced.

In the recovering of the refined oil from which impurities have been removed (S3), the mixed gas of (S2) is removed by discharging the gas, and the refined oil may be gas-liquid separated from the mixed gas and recovered. A temperature before the refined oil is recovered may be maintained at 290° C. or higher and lower than 350° C. When the temperature is maintained at 290° C. or higher, the production of an ammonium salt (NH₄Cl) from remaining impurities present in the refined oil may be prevented, and a high-quality refined oil having a minimized moisture content may be recovered. When the temperature before the refined oil is recovered is 290° C. or lower, moisture may be condensed or differential pressure may occur by the production of an ammonium salt (NH₄Cl), and when the temperature is 350° C. or higher, the catalyst may be deactivated by the occurrence of a thermal cracking side reaction.

In an exemplary embodiment of the present disclosure, a reaction pressure in the hydrotreating of (S1) and (S2) may be more than 60 bar and less than 120 bar. Under the conditions of a low pressure of 60 bar or less, impurities including chlorine and nitrogen may not be effectively removed, and under the conditions of a high pressure of 120 bar or more, production of an ammonium salt (NH₄Cl) may be promoted. The reaction pressure may be, specifically 65 bar to 110 bar, and more specifically 70 bar to 100 bar.

In an exemplary embodiment of the present disclosure, a liquid hourly space velocity (LHSV) ratio in the hydrotreating between (S1) and (S2) may be 1:0.1 to 1:0.8. When it is satisfied, impurities may be effectively removed through the hydrotreating of (S1) and (S2), the activity of the hydrotreating catalyst may be maintained with high activity for a long time, and process efficiency may be improved.

In the method of refining a waste plastic pyrolysis oil, for the matters which are not further described, see the descriptions for the waste plastic pyrolysis oil refining equipment described above.

The refined oil obtained by the waste plastic pyrolysis oil refining equipment or the method of refining a waste plastic pyrolysis oil has an extremely low content of impurities, and for example, may contain 10 ppm (by weight) or less of chlorine, 30 ppm (by weight) of less of nitrogen, 10 ppm (by weight) or less of sulfur, 10 ppm (by weight) or less of other metal components, 0.1 wt % or less of oxygen, 10 vol % or less of olefin, and 0.2 vol % or less of conjugated diolefin. However, it is described as a specific example, and is not interpreted as being limited thereto.

The refined oil obtained by the waste plastic pyrolysis oil refining equipment and the method of refining a waste plastic oil according to an exemplary embodiment of the present disclosure may have various pour points, and for example, may be wax which has a pour point of 0° C. or higher and is solid at room temperature.

Hereinafter, the present disclosure will be described in detail by the examples, but the examples are for describing the present disclosure in more detail, and the scope of the present disclosure is not limited to the following examples.

### Example 1

As shown in FIG. 1, equipment in which a guard bed 100, a main bed 200, and a recovery tank 300 are connected in series was designed, and an electric heater 250 was designed between the main bed 200 and the recovery tank 300. The equipment was operated to obtain a refined oil from which impurities have been removed, from the waste plastic pyrolysis oil.

The waste plastic pyrolysis oil used as a raw material was a hydrocarbon oil fraction mixture containing high-concentration impurities of 1.000 ppm of nitrogen (N), 700 ppm of chlorine (Cl), 18 wt % or more of olefin, 2.3 wt % of conjugated diolefin, and 1 wt % of moisture. It was confirmed from a Simdis analysis that the hydrocarbon oil fraction mixture included 20 wt % of naphtha (bp<180° C., ˜C8), 28 wt % of KERO, 16 wt % of LGO, and 36 wt % of VGO, and the total olefins were confirmed to be included at 40% of the total oil fractions from a Br Index analysis.

A hydrotreating catalyst was pre-treated by the following procedures to activate the catalyst. An R-LGO oil fraction including 2.5 wt % of dimethyl disulfide (DMDS) was treated under the conditions of 60 bar of H₂ and 170° C. for 2 hours, and then the temperature was raised to 320° C. and maintained for 3 hours to activate the catalyst.

Specifically, NiMo/r-Al₂O₃ and CoMo/r-Al₂O₃ which were the hydrotreating catalyst were provided inside the guard bed 100, the waste plastic pyrolysis oil and hydrogen gas were introduced into the guard bed 100, respectively, and a hydrotreatment was performed under the conditions of 250° C., 80 bar, H₂/oil ratio of 840, and LHSV 0.4 h⁻¹ to remove a chlorine component from the waste plastic pyrolysis oil, thereby producing hydrogen chloride as a by-product. Besides, olefin, metal impurities, and the like were removed together from the waste plastic pyrolysis oil by the reaction, in addition to the chlorine component.

A fluid including the waste plastic pyrolysis oil from which a chlorine component had been removed, hydrogen chloride, and unreacted hydrogen gas in the guard bed 100 was introduced to the main bed 200.

The same as the hydrotreating catalyst was provided inside the main bed 200, the fluid and the hydrogen gas were introduced to the main bed 200, respectively, and a hydrotreatment was performed under the conditions of 370° C., 85 bar, H₂/oil ratio of 840, and LHSV 0.7 h⁻¹ to remove a nitrogen component from the fluid, thereby producing ammonia as a by-product. Besides, other remaining impurities such as a small amount of chlorine component which had not been removed, sulfur component, and oxygen component were removed together, in addition to the nitrogen component.

Further, a mixed gas including ammonia, a small amount of hydrogen chloride which had not been removed, water, hydrogen sulfide, hydrogen, and the like present in the main bed 200 was discharged through a gas outlet of the main bed 200, and the refined oil from which impurities have been removed was recovered to the recovery tank 300 through an oil fraction outlet of the main bed 200. The temperature of the path from the main bed 200 to the recovery tank 300 was maintained at 330° C. by the electric heater 250.

### Example 2

A refined oil was obtained in the same manner as in Example 1, except that the guard bed 100 was operated under the conditions of 160° C. and 85 bar and the main bed 200 was operated under the conditions of 360° C. and 90 bar.

### Example 3

A refined oil was obtained in the same manner as in Example 1, except that the temperature of the path from the main bed 200 to the recovery tank 300 was maintained at 300° C.

### Comparative Example 1

A refined oil was obtained in the same manner as in Example 1, except that the reaction conditions of the guard bed were the same as those of the main bed.

### Comparative Example 2

A refined oil was obtained in the same manner as in Example 1, except that the electric heater 250 was not installed between the main bed 200 and the recovery tank 300.

### Comparative Example 3

A refined oil was obtained in the same manner as in Example 1, except that a cleaning tank was installed between the guard 100 and the main bed 200 and a water treatment was performed.

### Evaluation Example

A chlorine (Cl) content (ppm) and a nitrogen (N) content (ppm) were measured by ICP and XRF analysis methods and are shown.

An amount of time during which operation may be performed without a pressure drop problem while continuously producing a refined oil was measured to evaluate an ammonium salt (NH₄Cl) suppression effect. Specifically, a maximum operation time taken until a pressure loss (delta P) was 7 bar was measured, and the results therefor are shown in Table 1.

TABLE 1

| | | | | | Comparative Examples | | |
|---|---|---|---|---|---|---|---|
| | | Examples | | | | | 3 (water |
| | | 1 | 2 | 3 | 1 | 2 | treated) |
| Guard bed | Reaction | 250 | 160 | 250 | 370 | 250 | 250 |
| | temperature | | | | | | |
| | (° C.) | | | | | | |
| | Pressure (bar) | 80 | 85 | 80 | 85 | 80 | 80 |
| Main bed | Reaction | 370 | 360 | 370 | 370 | 370 | 370 |
| | temperature | | | | | | |
| | (° C.) | | | | | | |
| | Pressure (bar) | 85 | 90 | 85 | 85 | 85 | 85 |

| Temperature (° C.) of | 330 | 330 | 300 | 330 | — | 330 |
|---|---|---|---|---|---|---|
| path recovered from main | | | | | | |
| bed to recovery tank | | | | | | |
| Cl₀ (ppm; weight) | 700 | | | | | |
| Cl₁ (ppm; weight) | 164 | 181 | 164 | <50 | 164 | 164 |
| Cl₂ (ppm; weight) | <1 | <2 | <1 | <2 | <1 | <1 |
| N₀ (ppm; weight) | 1000 | | | | | |
| N₁ (ppm; weight) | 957 | 970 | 957 | <70 | 957 | 957 |
| N₂ (ppm; weight) | <1 | <1 | <3 | <3 | <1 | <1 |
| Moisture content (ppm) in | 50 | 53 | 55 | 47 | 50 | 800 |
| refined oil of main bed | | | | | | |
| Maximum operation time | >20 | >20 | >19 | 5 | 5 | 4 |
| (day) until pressure loss | | | | | | |

Cl₀: a weight of chlorine contained in waste plastic pyrolysis oil introduced to the guard bed
Cl₁: a weight of chlorine in an oil fraction immediately after passing through the guard bed
Cl₂: a weight of chlorine in a refined oil recovered to the recovery tank
N₀: a weight of nitrogen contained in waste plastic pyrolysis oil introduced to the guard bed
N₁: a weight of nitrogen in an oil fraction immediately after passing through the guard bed
N₂: a weight of nitrogen in a refined oil recovered to the recovery tank

Referring to Table 1,

in Examples 1 to 3, it was confirmed that the contents of chlorine (Cl) and nitrogen (N) in the recovered refined oil was at a level of several ppm, and a high-quality refined oil having a moisture content lowered to 50 ppm or less was able to be obtained. In particular, it was confirmed that the temperature of the path recovered from the main bed to the recovery tank was 300° C. or higher, thereby significantly improving the maximum operation time before a pressure loss to 19 days.

However, in Comparative Example 1, it was confirmed that the maximum operation time was as significantly short as 5 days, and the main reason thereof is considered as being that the hydrotreatment was performed under the conditions of 370° C. and 85 bar both in the guard bed and the main bed, thereby increasing a pressure loss (delta P) due to the production of an ammonium salt (NH₄Cl).

In addition, in Comparative Example 2 also, it was confirmed that the maximum operation time was as significantly short as 5 days, and the main reason thereof is considered as being that the temperature of the path from the main bed to the recovery tank was not able to be adjusted due to the lack of the electric heater, thereby precipitating an ammonium salt (NH₄Cl) to increase a pressure loss (delta P).

In Comparative Example 3, it was confirmed that the content of moisture (ppm) in the refined oil in the main bed was as significantly high as 800 ppm, and the main reason thereof is considered as the water treatment process. As described above, the high moisture content in the refined oil causes corrosion throughout the process and causes a problem of lowering process efficiency.

Although the examples and the comparative examples have been described above, the present invention is not limited to the examples but may be made in various forms different from each other, and those skilled in the art will understand that the present invention may be implemented in other specific forms without departing from the spirit or essential feature of the present invention. Therefore, it should be understood that the exemplary embodiments described above are not restrictive, but illustrative in all aspects.

1. Waste plastic pyrolysis oil refining equipment comprising:
a guard bed where a waste plastic pyrolysis oil and a hydrogen gas are introduced and hydrotreated at a first temperature in the presence of a hydrotreating catalyst to produce a fluid from which chlorine has been removed;
a main bed where the fluid and the hydrogen gas are introduced from the guard bed and hydrotreated at a second temperature higher than the first temperature in the presence of a hydrotreating catalyst to produce a refined oil from which impurities have been removed; and
a recovery tank where the refined oil from which impurities have been removed is recovered from the main bed, wherein a temperature before the refined oil is recovered to the recovery tank is maintained at 290° C. or higher and lower than 350° C.

2. The waste plastic pyrolysis oil refining equipment of claim 1, wherein the waste plastic pyrolysis oil includes 30 wt % or more of a medium to large hydrocarbon oil fraction of C10 or higher having a boiling point of 180° C. or higher.

3. The waste plastic pyrolysis oil refining equipment of claim 1, wherein the first temperature is higher than 100° C. and lower than 300° C. and the second temperature is higher than 300° C. and lower than 450° C.

4. The waste plastic pyrolysis oil refining equipment of claim 1, wherein a moisture content in the refined oil from which impurities have been removed in the main bed is less than 100 ppm.

5. The waste plastic pyrolysis oil refining equipment of claim 1, further comprising: a heating means between the main bed and the recovery tank.

6. The waste plastic pyrolysis oil refining equipment of claim 1, wherein a reaction pressure of the guard bed and the main bed is more than 60 bar and less than 120 bar.

7. The waste plastic pyrolysis oil refining equipment of claim 1, wherein a liquid hourly space velocity (LHSV) ratio between the guard bed and the main bed is 1:0.1 to 1:0.8.

8. A method of refining a waste plastic pyrolysis oil, the method comprising:
(S1) hydrotreating a waste plastic pyrolysis oil with a hydrogen gas at a first temperature in the presence of a hydrotreating catalyst to produce a fluid from which chlorine has been removed;
(S2) hydrotreating the fluid with a hydrogen gas at a second temperature higher than the first temperature in the presence of a hydrotreating catalyst to produce a refined oil from which impurities have been removed; and
(S3) recovering the refined oil from which impurities have been removed, wherein a temperature before the refined oil is recovered is maintained at 290° C. or higher and lower than 350° C.

9. The method of refining a waste plastic pyrolysis oil of claim 8, wherein the waste plastic pyrolysis oil includes 30 wt % or more of a medium to large hydrocarbon oil fraction of C10 or higher having a boiling point of 180° C. or higher.

10. The method of refining a waste plastic pyrolysis oil of claim 8, wherein the first temperature is higher than 100° C. and lower than 300° C., and the second temperature is higher than 300° C. and lower than 450° C.

11. The method of refining a waste plastic pyrolysis oil of claim 8, wherein a moisture content in the refined oil from which impurities have been removed in (S2) is less than 100 ppm.

12. The method of refining a waste plastic pyrolysis oil of claim 8, wherein a reaction pressure in the hydrotreating of (S1) and (S2) is more than 60 bar and less than 120 bar.

13. The method of refining a waste plastic pyrolysis oil of claim 8, wherein a liquid hourly space velocity (LHSV) ratio in the hydrotreating between (S1) and (S2) is 1:0.1 to 1:0.8.
